(19) United States
(12) Patent Application Publication
(10) Pub. No.: US 2008/0176565 A1
(43) Pub. Date: Jul. 24, 2008

(54) Apparatus, method and computer program product providing rat priority list for multi-rat mobile devices

(75) Inventors: Lauri Eerolainen, Salo (FI); Juha Vasarainen, Angelniemi (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/656,620

(22) Filed: Jan. 23, 2007

(51) Int. Cl. H04Q 7/20

(52) U.S. Cl. 455/436

(57) ABSTRACT

A method, computer program product and a wireless network node operate to determine a content of a multi-radio access technology priority list that includes n entries (n>1) prioritized from a highest priority radio access technology to a lowest priority radio access technology, where an entry for the highest priority radio technology includes a measurement delay timer value, and to send the determined multi-radio access technology priority list to a user equipment. The user equipment stores the multi-radio access technology priority list and sends measurement results to the wireless communications network for one of the n entries that is associated with a currently camped-on radio access technology and for one of the n entries that is associated with an active neighbor radio access technology. In response to detecting a loss of the highest priority radio access technology, the user equipment initializes a timer to the timer value and terminates further making measurements from a cell associated with the highest priority radio access technology until the timer expires.

### TECHNICAL FIELD

The exemplary and non-limiting embodiments of this invention relate generally to wireless communication systems, methods, devices and computer program products and, more specifically, relate to techniques to provide inter-radio access technology operation of a user equipment.

### BACKGROUND

Various abbreviations that appear in the specification and/or in the drawing figures are defined as follows:
2G 2nd generation mobile communication system, for example GSM
3G 3rd generation mobile communication system, for example WCDMA
3.9G advanced 3rd generation communication system, for example EUTRAN
BA BCCH allocation
BCCH broadcast control channel
BSIC base transceiver station identity code
CN core network
DL downlink
EDGE enhanced data rates for GSM evolution
EUTRAN evolved universal terrestrial radio access network
FDD frequency division duplex
GSM global system for mobile communications
HO handover
LTE long term evolution
Node-B base station
eNB evolved Node-B
MS mobile station
NW network
RAT radio access technology
SACCH slow associated control channel
SDCCH stand-alone dedicated control channel
TCH traffic channel
TDD time division duplex
UE user equipment
UL uplink
UTRAN universal terrestrial radio access network
WCDMA wideband code division multiple access
PS packet scheduler
MRHC measurement report handling and control
WiMAX worldwide interoperability for microwave access (IEEE 802.16 standard)
WLAN wireless local area network

It may be anticipated that future mobile devices (which may be collectively referred to as MSs and/or UEs or simply as UEs) will support several RATs (e.g. 2G/3G/3.9G and beyond). In order to provide seamless service to the UE in a case where it moves outside of the coverage of a current “camped on”/active RAT, measurement reports need to be sent to the NW. In response to the measurement reports the NW may order the UE to make a HO to a better cell, or possibly to operate with a different RAT.

As used herein, the term RAT refers to a radio access technology for a wireless communication system. A RAT may be utilized in conjunction with a cellular system or a non-cellular system.

A mobile device that supports at least three different RATS may be referred to herein as a “multi-RAT” mobile device (or MS, or UE).

To be able to provide the UE a seamless service and maintain mobility in the case of the UE moving outside the coverage of the current “camped on”/active RAT the UE needs to send radio link measurement reports (e.g., based on quality measurements) to the NW when the UE is in an active connection (e.g., during a data transfer). According to the measurement reports the NW can order the UE to perform some action in an attempt to improve the active connection (e.g., make a handover to a better cell, or to change the RAT). In the idle state UE must evaluate the measurement results autonomously and perform reselections if needed.

As an example, assume a phone call is started in a 3G NW and that the UE then moves outside the 3G radio coverage area. The NW takes note of this movement from the measurement reports sent by the UE and commands the UE to change the active RAT to 2G. The phone call then continues, ideally providing seamless service to the UE.

However, for the case of the multi-RAT UE, it must measure several RATs. This requirement results in increased power consumption, as less low power operation, or sleep time, is possible for the UE. Further, more complex measurement scheduling may be required by the UE, and more complex HO/reselection algorithms may be required for both the NW and UE. In addition, the measurement reporting becomes more complex. Further still, the Ut data throughput can be reduced if UE resources are used for measuring several additional RATs.

Currently inter-RAT measurements are handled as specified in 3GPP specifications. For example, when the UE is camped on a 2G network the inter-RAT handover measurements are defined in 3GPP TS 45.008, V7.6.0 (2006-11), 3rd Generation Partnership Project; Technical Specification Group GSM/EDGE Radio Access Network; Radio subsystem link control (Release 7), in subclause 7.3. According to this particular specification the inter-RAT measurements are controlled by different threshold parameters and a neighbor list (a list of neighboring base stations).

More specifically, subclause 7.3 “Handover measurements on other radio access technologies” states that for a multi-RAT MS, the network controls the identification and measurements of cells belonging to other radio access technologies by a parameter Qsearch_C sent on the SACCH or, if Qsearch_C is not received, by Qsearch_C_Initial sent on the BCCH. Qsearch_C defines a threshold and also indicates whether these tasks shall be performed when RXLEV (see subclause 8.1.3) of the serving BCCH carrier is below or above the threshold. The MS may use the search frames, which are not required for BSIC decoding, for these measurements. If indicated by the parameter 3G_SEARCH_PRIO, the MS may use up to 25 search frames per 13 seconds without considering the need for BSIC decoding in these frames.

If the serving cell is not included in the BA(SACCH) list, the dedicated channel is not on the BCCH carrier, and Qsearch_C is not equal to 15, the MS shall disregard the Qsearch_C parameter value and always search for cells belonging to other radio access technologies. If Qsearch_C is equal to 15, the MS shall never search for cells on other RAT.

The MS shall report a new best UTRAN cell, which is part of the neighbor cell list, at the latest 5 seconds after it has been activated under the condition that there is only one UTRAN frequency in the neighbor cell list and that no new GSM cells are activated at the same time, and under good radio conditions.

The allowed reporting time is increased by 5 seconds for each additional UTRAN frequency in the neighbor cell list and by the time required for BSIC decoding of new activated GSM cells. However, multiple UTRAN cells on the same frequency in the neighbor cell list does not increase the allowed reporting time.

When on a TCH, identification of a TDD cell is guaranteed only in the case of single slot operation and, for a 3.84 Mcps option, if the TDD cell uses synchronization option 2 (see 3GPP TS 25.221). In all other cases, the MS may not be able to fulfill the requirement above. If after 5 seconds the MS has not been able to identify a TDD cell, the MS is allowed to stop searching for it in the current GSM cell.

When on SDCCH, the MS may use all TDMA frames, which are not part of the assigned channel or that are required for GSM signal strength measurements, for the above task. In this case the allowed reporting time is 1.7 seconds, with the same assumptions as above.

A multi-RAT MS shall be able to monitor 64 cells from other radio access technologies, divided into (depending on the MS capability): FDD cells on up to 3 FDD frequencies, with a maximum of 32 cells per frequency; TDD cells on up to 3 TDD frequencies, with a maximum of 32 cells per frequency; and/or CDMA2000 cells.

As can be appreciated, this conventional inter-RAT approach does not address and solve the problems that were discussed above.

### SUMMARY OF THE EXEMPLARY EMBODIMENTS

The foregoing and other problems are overcome, and other advantages are realized, in accordance with the non-limiting and exemplary embodiments of this invention.

In accordance with a first exemplary aspect thereof the embodiments of this invention provide a method that comprises determining in a wireless communication network a content of a multi-radio access technology priority list comprising n entries (n>1) prioritized from a highest priority radio access technology to a lowest priority radio access technology, where an entry for the highest priority radio technology comprises a measurement delay timer value; and sending by any suitable means the determined multi-radio access technology priority list to a user equipment.

In accordance with another exemplary aspect thereof the embodiments of this invention provide a computer program product embodied on a tangible medium and comprising instructions that, when executed by at least one data processor, result in operations that comprise determining in a wireless communication network a content of a multi-radio access technology priority list comprising n entries (n>1) prioritized from a highest priority radio access technology to a lowest priority radio access technology, where an entry for the highest priority radio technology comprises a measurement delay timer value; and sending the determined multi-radio access technology priority list to a user equipment.

In accordance with another exemplary aspect thereof the embodiments of this invention provide a wireless network node that includes at least one functional unit adapted to determine a content of a multi-radio access technology priority list comprising n entries (n>1) prioritized from a highest priority radio access technology to a lowest priority radio access technology, where an entry for the highest priority radio technology comprises a measurement delay timer value. The wireless network node further includes a wireless transceiver configured to send the determined multi-radio access technology priority list to a user equipment and to receive a measurement report from the user equipment.

In accordance with a further exemplary aspect thereof the embodiments of this invention provide a method that includes storing information descriptive of a multi-radio access technology priority list comprising n entries (n>1) prioritized from a highest priority radio access technology to a lowest priority radio access technology, where an entry for the highest priority radio technology comprises a timer value; sending measurement results to a wireless communications network for one of the n entries that is associated with a currently camped-on radio access technology and for one of the n entries that is associated with an active neighbor radio access technology and, in response to detecting a loss of the highest priority radio access technology, initializing a timer to the timer value and terminating making further measurements from a cell associated with the highest priority radio access technology until the timer expires.

In accordance with a further exemplary aspect thereof the embodiments of this invention provide a computer program product embodied on a tangible medium and comprising instructions that, when executed by a data processor of a user equipment, result in operations that comprise storing information descriptive of a multi-radio access technology priority list comprising n entries (n>1) prioritized from a highest priority radio access technology to a lowest priority radio access technology, where an entry for the highest priority radio technology comprises a timer value; storing the multi-radio access technology priority list; sending measurement results to a wireless communications network for one of the n entries that is associated with a currently camped-on radio access technology and for one of the n entries that is associated with an active neighbor radio access technology and, in response to detecting a loss ofthe highest priority radio access technology, initializing a timer to the timer value and terminating further measurements from a cell associated with the highest priority radio access technology until the timer expires.

In accordance with yet a still further exemplary aspect thereof the embodiments of this invention provide a user equipment having at least one transceiver adapted for wireless communication with a plurality of different radio access technologies, and further comprising a control unit operatively coupled with a memory that stores information descriptive of a multi-radio access technology priority list comprising n entries (n>1) prioritized from a highest priority radio access technology to a lowest priority radio access technology, where an entry for the highest priority radio technology comprises a timer value. The control unit is adapted to send measurement results to a wireless communications network for one of the n entries that is associated with a currently camped-on radio access technology and for one of the n entries that is associated with an active neighbor radio access technology. The control unit is further adapted to respond to detecting a loss of the highest priority radio access technology to initialize a timer to the timer value and to terminate further measurements from a cell associated with the highest priority radio access technology until the timer expires.

### BRIEF DESCRIPTION OF THE DRAWINGS

The foregoing and other aspects of the exemplary embodiments of this invention are made more evident in the following Detailed Description, when read in conjunction with the attached Drawing Figures, wherein:

FIG. 1 is a simplified block diagram of a wireless communication network and UE that are suitable for implementing the exemplary embodiments of this invention.

FIG. 2 is a logic flow diagram that illustrates a method, and the operation of a computer program product, that is applicable to the user equipment shown in FIG. 1.

FIG. 3 is a logic flow diagram that illustrates a method, and the operation of a computer program product, of a wireless network node, such as the Node-B shown in FIG. 1.

FIG. 4 is another logic flow diagram that illustrates a method, and the operation of a computer program product, of the user equipment shown in FIG. 1.

### DETAILED DESCRIPTION

As employed herein a 3.9G RAT is assumed to be one compatible with EUTRAN, also referred to as UTRAN-LTE, for which specification and standardization efforts are on-going. A 2G RAT may be compatible with, as non-limiting examples, GPRS/EDGE, GSM or PDC, while a 3G RAT may be one compatible with, as non-limiting examples, UMTS, WCDMA and cdma2000.

3GPP TS 45.008 V7.6.0, in sections 8.4.7 and 10.1.4, refers to a MULTIRAT_REPORTING parameter. Indirectly the MULTIRAT_REPORTING parameter informs the UE of the RATs the UE should to measure. For idle mode, these reporting parameters are not valid. In addition, Qsearch parameters indirectly tell the UE which RATs the UE should to measure. As specified, these parameters do not indicate priorities between RATs.

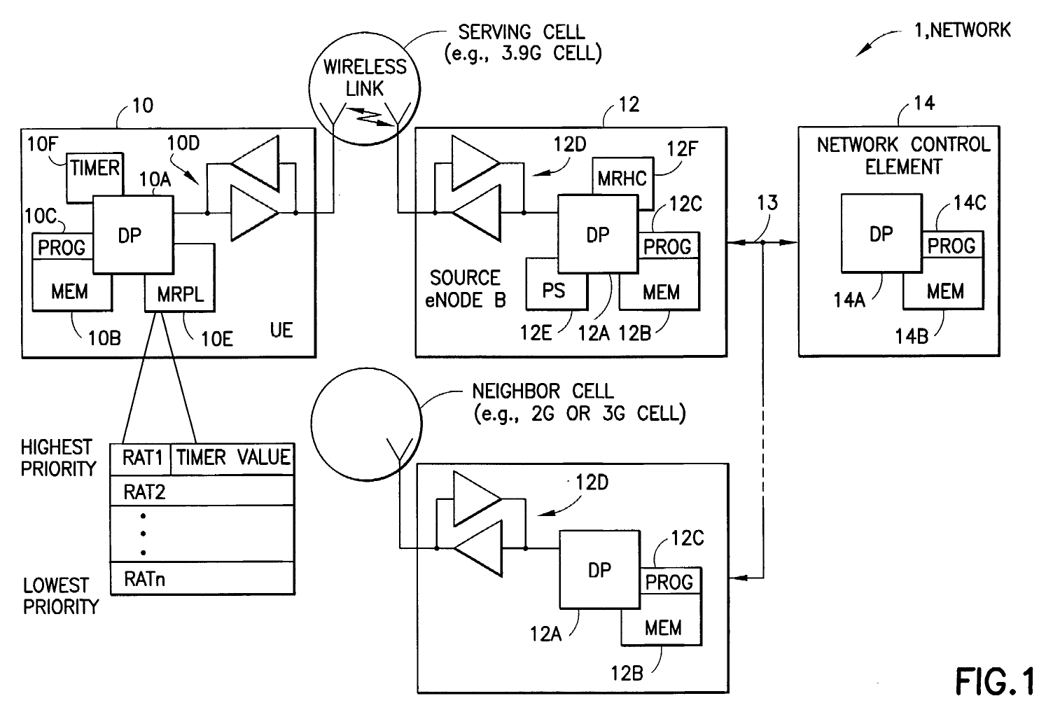

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node-B (base station) 12. The network 1 may include, as part of a CN, a network control element (NCE) 14, which in an EUTRAN system may be an access gateway (aGW). The UE 10 includes at least one control unit such as a data processor (DP) 10A, a memory (MEM) 10B that stores a program (PROG) 10C, and at least one suitable wireless, e.g., radio frequency (RF) transceiver 10D for bidirectional wireless communications with the Node B 12, which also includes a DP 12A, a MEM 12B that stores a PROG 12C, and a suitable RF transceiver 12D. The Node-B 12 is shown as including a PS 12E, and may also include a MRHC function 12F. Note that the PS 12E and MRHC function 12F need not both be co-located within any one physical device or node of the network 1. The Node B 12 is coupled via a data path 13 to the NCE 14 that also includes a DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail.

Although shown in FIG. 1 with a PS 12E, the exemplary embodiments of this invention may also be utilized in a network that does not include a PS 12E (e.g., a circuit switched network).

Also shown is a second base station (BS) 12′, which may also be a Node-B, and which may be considered to be a neighbor BS. The neighbor BS may be of a different RAT type, e.g., a BS associated with a 2G, 3G, WiMAX or Bluetooth® RAT, as non-limiting examples. The cell of the Node-B 12 (which may be a currently serving cell of the UE 10) may or may not be adjacent to the cell of the BS 12′. Further, while only one BS 12′ is shown, typically there will be several that qualify at any given time as neighbor BSs. The BS 12′ also includes a DP 12A, MEM 12B, PROG 12C and wireless transceiver 12D. Note that while the BS 12′ may operate in accordance with a different RAT than the Node-B 12, it may also be connected to the same CN as the Node-B 12.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10, the DP 12A of the Node-B 12 and the other DPs, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

In accordance with the exemplary embodiments of this invention the NW (e.g., the PS 12E in cooperation with the MRHC function 12F) includes logic to construct a multi-RAT priority list as discussed below, to signal the constructed multi-RAT priority list to the UE 10, and the UE 10 includes memory (e.g., the memory 10B) for storing the multi-RAT priority list, shown in FIG. 1 as the MRPL 10E. The use of the multi-RAT priority list 10E provides a simple way to manage the complexity involved when the UE 10 operates with multi-RATs, as described in further detail below.

In accordance with the exemplary embodiments of this invention the NW provides the multi-RAT UE 10 with the multi-RAT priority list 10E that contains indications of preferred RATs. In other words, the multi-RAT priority list 10E may contain identifying information for all RATs that the NW supports and/or that the NW wants the UE 10 to prefer in a particular geographical area. Based on multi-RAT priority list 10E the UE 10 is enabled to focus only on measuring, e.g., one or two RATs and may ignore the rest. In general, and as will be explained below, the multi-RAT UE 10 need not focus on and measure lower priority RATs unless coverage is lost from a higher priority RAT.

In the exemplary embodiments of this invention it is preferred that the NW does not include RATs in the multi-RAT priority list 10E that would not be possible for the UE 10 to find (e.g., a RAT that the UE 10 does not have the hardware or software to support, or a RAT whose coverage area the UE 10 is too far from to receive).

As a non-limiting example, RAT cell-specific parameters may be defined in a neighbor list in the UE 10. In other embodiments, the UE 10 may not comprise a neighbor list. As a non-limiting example, in such embodiments, the UE 10 may perform a cell search in the selected RAT(s).

The first RAT in the list 10E (RAT. 1 in FIG. 1) has the highest priority and the last. RAT in the list 10E (RAT n in FIG. 1) has the lowest priority. The entry for the highest priority RAT in the multi-RAT priority list 10E also preferably includes an indication of a maximum value for a timer 10F (shown as TIMER in FIG. 1, and which may be referred to as a search delay timer). The timer 10F may be implemented as a hardware timer and/or as a software timer. The timer value is a RAT-specific maximum “ignore period” after which the highest priority RAT is to be searched for in case it has been lost. The use of the timer value ensures that UE 10 does not continuously remain in communication via a lower priority RAT after losing the highest priority RAT.

For purposes of illustration, in the exemplary embodiments of this invention the value of n is set to three in the multi-RAT priority list 10E, although this specific value should not be viewed as a limitation, as a value greater than three could also be used to list more than three RATs.

Further, in the exemplary embodiments of this invention the highest priority RAT (RAT 1) is defined to be the target RAT, and it is the one that is searched for by the UE 10 after expiration of the timer 10F, which is set according to the timer value in the multi-RAT priority list 10E. In this case the UE 10, upon detecting that the RAT 1 has been lost for any reason, initializes the timer 10F to the timer value, and when the timer 10F expires the UE 10 begins searching for a signal from the RAT 1 in an attempt to re-establish the connection to the highest priority RAT.

Further, in the exemplary embodiments of this invention the multi-RAT priority list 10E is employed as well during UE 10 reselection procedures, and when constructing the UE 10 measurement reports to be sent to the NW. This is beneficial, as it facilitates the handover logic in the NW since the NW need process only measurement results from (n−1) RATs (e.g., from two RATS when n=3).

The operation of the exemplary embodiments of this invention is explained further with regard to the following exemplary and non-limiting use cases.

Use case 1: Basic Idle/reselection

Assume that the UE 10 supports three RATs: e.g., 2G, 3G and 3.9G RATs, and that the NW has sent the UE 10 the following multi-RAT priority list 10E:

1.3.96, timer value 3 seconds (note: the 3.9G RAT is a current camped-on RAT)

2.3G (active neighbor RAT)

3.2G

Assume further that the UE 10 is in the Idle mode and is camped on the 3.9G RAT. The UE 10 measures the 3.9G RAT according to UE 10 3.9G RAT-specific rules and also 3G RAT measurements are made. The 2G is ignored (not measured).

As a result of a reselection procedure evaluation in the UE 10 it is decided to change the RAT from 3.9G to 3G and the NW is informed. The reselection may occur because of some signal impairment with the 3.9G RAT, or for any reason that can trigger a reselection procedure.

Subsequently the UE 10 receives the following multi-RAT priority list 10E from the 3G RAT (the one to which it has reselected):

1.3.9G, timer value 3 seconds (active neighbor RAT)

2.3G (note: The 3G RAT is now the current camped-on RAT)

3.2G

Note in this case that the 3.9G RAT is still indicated as being the highest priority RAT, even though the UE 10 is now camped on the 3G RAT.

Assume now that the UE 10 remains in the Idle mode camped on the 3G RAT. The UE 10 measures the 3.9G RAT according to, UE 10 RAT-specific rules and also 3G RAT measurements are made. The 2G is ignored (not measured). Assume that valid measurement results are measured from both the 3.9G RAT and the 3G RAT.

In the reselection evaluation the 3.9G RAT is preferred over the 3G RAT because it is listed as having a higher priority in the latest multi-RAT priority list 10E. As a result, the UE 10 reselects back to the 3.9G RAT as soon as it detects adequate signal strength (and/or some other reception-related metric).

Use case 2: Idle/reselection, high priority RAT timer 10F is used

Assume again that the UE 10 supports three RATs: e.g., 2G, 3G and 3.9G RATs, and that the NW has sent the UE 10 the following multi-RAT priority list 10E:

1.3.9G, timer value 3 seconds (note: the 3.9G RAT is a current camped-on RAT)

2.3G (active neighbor RAT)

3.2G

Assume further that the UE 10 is in the Idle mode and is camped on the 3.9G RAT. The UE 10 measures the 3.9G RAT according to UE 10 RAT-specific rules and also 3G RAT measurements are made. The 2G is ignored (not measured).

For a case where no adequate or “good” 3G cells are measured, the next RAT in the multi-RAT priority list 10E is selected for the neighbor RAT measurements, i.e., in this example the 2G RAT is selected for measurement purposes.

This means that the RAT priority list is used as follows:

1.3.9G, timer value 3 seconds (note: the 3.9 RAT is the current camped-on RAT)

2.3G

3.2G (active neighbor RAT)

The UE 10 continues in the Idle mode camped on the 3.9G RAT, and it measures the 3.9G RAT according to RAT specific rules and also 2G RAT measurements are made. Note that in this case the 3G RAT is ignored (not measured) until a new multi-RAT priority list 10E is received.

Assume that the UE 10 makes a 3.9G RAT to 2G RAT reselection for whatever reason, and that the new multi-RAT priority list 10E is received from the NW via the 2G RAT:

1.3G, timer value 5 seconds (note: active neighbor RAT)

2.2G, (note: current camped on RAT)

3.3.9G

Upon receipt of this multi-RAT priority list 10E from the 2G RAT the 5 second 3G timer 10F is started, and 2G RAT measurements continue. The 3.9G RAT is ignored and not measured. After the 3G RAT timer 10F expires, measurements are also attempted for the 3G RAT, and when the measurements are satisfactory, the UE 10 reselects to the 3G RAT.

Use case 3: Handover (high data rate, e.g., receiving streaming video)

Assume again that the UE 10 supports three RATs: e.g., 2G, 3G and 3.9G RATs. Assume further that the UE 10 is camped-on the 3G RAT and is in the connected mode with a high data rate connection, and that the NW has sent the UE 10 the following multi-RAT priority list 10E:

1.3.9G, timer value 3 seconds (active neighbor RAT)

2.3G (note: the 3.9 RAT is a current camped-on RAT)

3.2G

The UE 10 measures the 3.9G RAT and the 3G RAT. The 2G RAT is ignored (not measured). The UE 10 fills the measurement report first with results from measuring the 3.9G RAT (the highest priority RAT) and, if room is available, 3G RAT measurement report results are included. The measurement report is sent on the UL to the NW via the 3GRAT.

Assume next that the NW sends the UE 10 a HO command and the UE 10 changes from the 3G RAT to the 3.9G RAT, thereby permitting the high data rate application to continue seamlessly with a high quality of service.

Subsequently the UE 10 receives the following multi-RAT priority list 10E in the 3.9G RAT:

1.3.9G, timer value 3 seconds (note: the 3.9 RAT is the current camped-on RAT)

2.3G (active neighbor RAT)

3.2G

Use case 4: handover (low data rate, e.g., normal phone call)

Assume again that the UE 10 supports three RATs: e.g., 2G, 3G and 3.9G RATs. Assume further that the UE 10 is camped-on the 3G RAT and is in the connected mode with a low data rate connection, and that the NW has sent the UE 10 the following multi-RAT priority list 10E:

1.3G, timer value 4 seconds (note: current camped on RAT)

2.2G (active neighbor RAT)

3.3.9G

The UE 10 measures the 3G RAT and the 2G RAT. The 3.9G RAT is ignored (not measured). The UE 10 fills the measurement report first with results from measuring the 3G RAT (the highest priority RAT in this case) and, if room is available, 2G RAT measurement report results are included. The measurement report is sent on the UL to the NW via the 3G RAT.

Assume that the NW sends the UE 10 a HO command and the UE changes from the 3G RAT to the 2G RAT since, in this case, it is assumed that the 2G RAT can support the low data rate connection (e.g., the 2G RAT is a GSM network that can readily support a normal phone call).

Subsequently the NW has sends the UE 10 the following RAT priority list 10E via the 2G RAT:

1.2G, timer value 6 seconds (note: current camped on RAT)

2.3G (active neighbor RAT)

3.3.9G

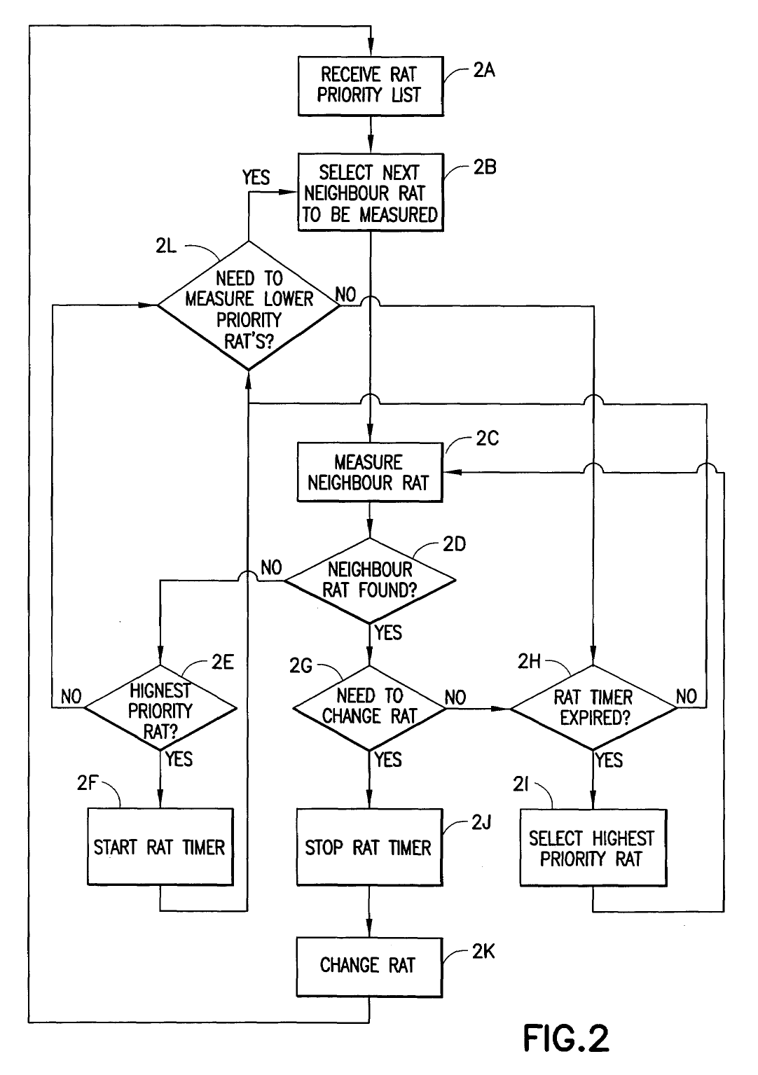

Reference is now made to FIG. 2 for showing a logic flow diagram that illustrates a method, and the operation of a computer program product, of the UE 10. At Block 2A the UE 10 receives and stores the multi-RAT priority list 10E. At Block 2B the UE 10 selects a neighbor RAT from the list 10E to be measured (the highest priority RAT in this case), and at Block 2C the UE 10 attempts to measure the neighbor RAT. At Block 2D a determination is made if the neighbor RAT was found and, if not, a determination is made at Block 2E if the neighbor RAT that was not found is the highest priority RAT in the multi-RAT priority list 10E. If it is not control passes to Block 2L to determine if RATs of a lower priority than the measured RAT are to be measured. If lower priority RATs are to be measured then control passes back to Block 2B to select and then measure the next RAT in the multi-RAT priority list 10E. However, if it is determined at Block 2E that the neighbor RAT that was not found is the highest priority RAT in the multi-RAT priority list 10E, then control passes to Block 2F to initialize and start the RAT timer 10F, after which control passes to Block 2L to determine if RATs of a lower priority than the measured RAT are to be measured. If the determination at Block 2D is such that the neighbor RAT is found, control passes to Block 2G to determine if there is a need to change to another RAT (e.g., was the measured signal strength below some threshold). If no need to change the RAT is determined, control passes to Block 2H to determine if the RAT timer 10F has expired and, if it has not, control passes to Block 2L to determine if RATs of a lower priority than the measured RAT are to be measured. If at Block 2H it is found that the RAT timer 10F has expired, then the method selects the highest priority RAT from the multi-RAT priority list 10E, and control passes back to Block 21. In this case, the measured neighbor RAT is a measurement of the highest priority RAT. If there is a need found at Block 2G to change the RAT, control passes to Block 2J to stop the RAT timer 10F (if started), followed by execution of Block 2K to change the RAT and receive another multi-RAT priority list 10E at Block 2A. In this exemplary embodiment, the UE stays in a measurement loop until a RAT change is needed (Block 2G), the RAT timer expires (Block 2H) or the neighbor RAT is not found and there are more RATs found from the priority list (Block 2D).

Note that the RAT change evaluation at Block 2G may be done by the UE 10 and/or by the NW. The RAT change may be performed autonomously by the UE 10, such as if user data rate that is required is not supported by the current RAT. Alternatively, that RAT change may be NW controlled for any of a number of reasons (e.g., changes in network loading). When the RAT change evaluation is performed only by the NW, the UE 10 may simply pass through Block 2G until commanded by the NW to change the RAT (i.e., Block 2G may always produce a “no” output until the NW commands the UE 10 to change the RAT).

In one non-limiting example, Qsearch criteria specified in 3GPP TS 45.008 can be processed in Block 2L. In another non-limiting example, Block 2G can implement reselection algorithms.

In the various embodiments discussed above the NW provides the UE 10 the multi-RAT priority list 10E via suitable signaling. As two non-limiting examples, in the 2G RAT the multi-RAT priority list 10E could be signaled as part of a Packet Measurement Order, or as part of Si2quarter/Measurement Information messages.

Note further in the various embodiments discussed above the UE 10 uses the multi-RAT priority list 10E also in reselection algorithms and when constructing measurement reports.

It is assumed that the NW includes suitable logic to create the multi-RAT priority list before it is signaled to the UE 10. This logic can reside in whole or in part in the PS 12E and/or MRHC 12F, as non-limiting examples. In a circuit switched network the logic may reside in whole or in part in one or more other network components. Note that from the foregoing use cases, and as non-limiting examples, the NW can consider the current user data rate requirement, network capacity issues and/or UE capability in constructing the multi-RAT priority list.

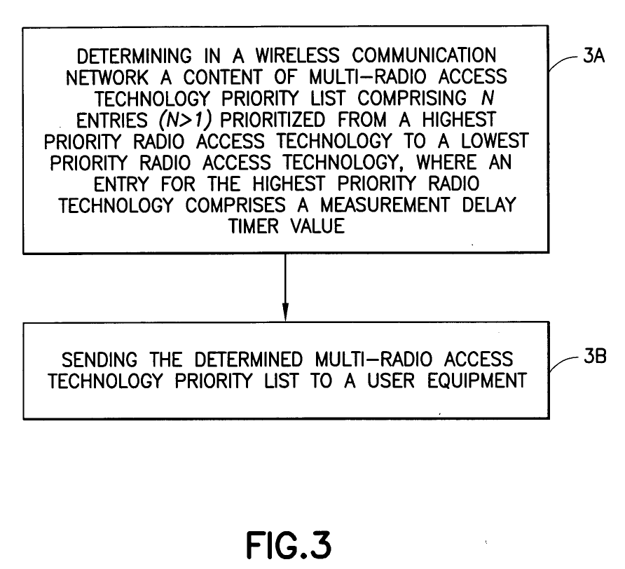

FIG. 3 is a logic flow diagram that illustrates an exemplary method, and the operation of a computer program product, of a wireless network node, such as the Node-B 12 shown in FIG. 1. A method includes (Block 3A) determining in a wireless communication network a content of a multi-radio access technology priority list comprising n entries (n>1) prioritized from a highest priority radio access technology to a lowest priority radio access technology, where an entry for the highest priority radio technology comprises a measurement delay timer value; and (Block 3B) sending the determined multi-radio access technology priority list to a user equipment.

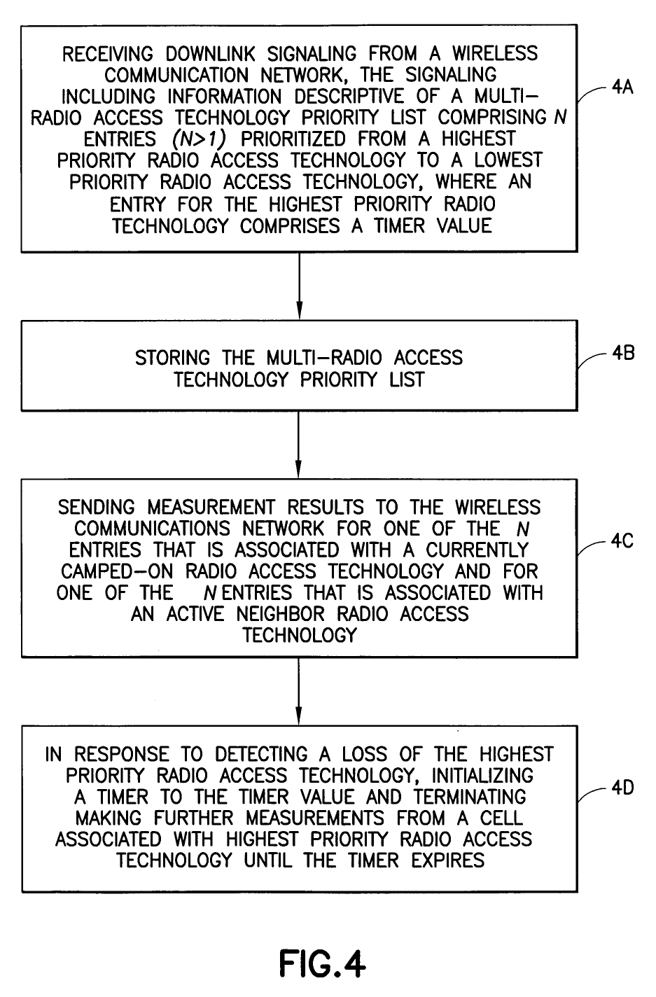

FIG. 4 is a logic flow diagram that illustrates an exemplary method, and the operation of a computer program product, of the user equipment 10 shown in FIG. 1. A method includes (Block 4A) receiving downlink signaling from a wireless communication network, the signaling including information descriptive of a multi-radio access technology priority list comprising n entries (n>1) prioritized from a highest priority radio access technology to a lowest priority radio access technology, where an entry for the highest priority radio technology comprises a timer value; (Block 4B) storing the multi-radio access technology priority list; and (Block 4C) sending measurement results to the wireless communications network for one of the n entries that is associated with a currently camped-on radio access technology and for one of the n entries that is associated with an active neighbor radio access technology. The method further includes (Block 4D), in response to detecting a loss of the highest priority radio access technology, initializing a timer to the timer value and terminating making further measurements from a cell associated with the highest priority radio access technology until the timer expires.

The various blocks shown in FIGS. 2, 3 and 4 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims.

For example, while the exemplary embodiments have been described above in the context of the EUTRAN (UTRAN-LTE), WCDMA and GSM systems, it should be appreciated that the exemplary embodiments of this invention are not limited for use with these particular types of wireless communication systems, and that they may be used to advantage in combination with other wireless communication systems. As non-limiting examples, the NW could add non-licensed systems (e.g., WLAN, Bluetooth®) to the multi-RAT priority list 10E.

Further, while described generally in the context of a UE 10 having a single receiver (single transceiver), the exemplary embodiments of this invention may be used as well with those UEs that include a plurality of receivers, such as those adapted for use in different frequency bands possibly using different modulation and coding schemes and different access technologies.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

1. A method, comprising:
determining in a wireless communication network a content of a multi-radio access technology priority list comprising n entries (n >1) prioritized from a highest priority radio access technology to a lowest priority radio access technology, where an entry for the highest priority radio technology comprises a measurement delay timer value; and
sending the determined multi-radio access technology priority list to a user equipment.

2. The method of claim 1, where n ≧3

3. The method of claim 1, where during use of the multi-radio access technology priority list further comprising the receiving at the wireless communication network a measurement report from the user equipment, the measurement report comprising measurement results for one of the n entries that is associated with a currently camped-on radio access technology and for one of the n entries that is associated with an active neighbor radio access technology.

4. The method of claim 3, where the measurement report does not comprise measurement results for one of the n entries that is not associated with either the currently camped-on radio access technology and the active neighbor radio access technology.

5. The method of claim 1, further comprising, in response to the user equipment handing over from a first radio access technology to a second radio access technology, each having an associated entry in the multi-radio access technology priority list, sending a revised multi-radio access technology priority list to the user equipment.

6. The method of claim 1, further comprising, in response to the user equipment reselecting from a first radio access technology to a second radio access technology, each having an associated entry in the multi-radio access technology priority list, sending a revised multi-radio access technology priority list to the user equipment.

7. The method of claim 1, where there are at least m potential radio access technology systems available to the wireless communication network, and where n≦m.

8. A computer program product embodied on a tangible medium and comprising instructions that, when executed by at least one data processor, result in operations that comprise:
determining in a wireless communication network a content of a multi-radio access technology priority list comprising n entries (n>1) prioritized from a highest priority radio access technology to a lowest priority radio access technology, where an entry for the highest priority radio technology comprises a measurement delay timer value; and
sending the determined multi-radio access technology priority list to a user equipment.

9. The computer program product of claim 8, where n≧3.

10. The computer program product of claim 8, where during use of the multi-radio access technology priority list further comprising an operation of receiving at the wireless communication network a measurement report from the user equipment, the measurement report comprising measurement results for one of the n entries that is associated with a currently camped-on radio access technology and for one of the n entries that is associated with an active neighbor radio access technology.

11. The computer program product of claim 10, where the measurement report does not comprise measurement results for one of the n entries that is not associated with either the currently camped-on radio access technology and the active neighbor radio access technology.

12. The computer program product of claim 8, further comprising an operation of, in response to the user equipment handing over from a first radio access technology to a second radio access technology, each having an associated entry in the multi-radio access technology priority list, sending a revised multi-radio access technology priority list to the user equipment.

13. The computer program product of claim 8, further comprising, in response to the user equipment reselecting from a first radio access technology to a second radio access technology, each having an associated entry in the multi-radio access technology priority list, sending a revised multi-radio access technology priority list to the user equipment.

14. The computer program product of claim 8, where there are at least m potential radio access technology systems available to the wireless communication network, and where n≦m.

15. A wireless network node, comprising at least one functional unit adapted to determine a content of a multi-radio access technology priority list comprising n entries (n>1) prioritized from a highest priority radio access technology to a lowest priority radio access technology, where an entry for the highest priority radio technology comprises a measurement delay timer value; and further comprising a wireless transceiver configured to send the determined multi-radio access technology priority list to a user equipment and to receive a measurement report from the user equipment.

16. The wireless network node of claim 15, where n≧3.

17. The wireless network node of claim 15, where the measurement report comprises measurement results for one of the n entries that is associated with a currently camped-on radio access technology and measurement results for one of the n entries that is associated with an active neighbor radio access technology, where the measurement report does not comprise measurement results for one of the n entries that is not associated with either the currently camped-on radio access technology and the active neighbor radio access technology.

18. The wireless network node of claim 15, said at least one functional unit being responsive to the user equipment handing over from a first radio access technology to a second radio access technology, each having an associated entry in the multi-radio access technology priority list, to determine a revised multi-radio access technology priority list to the user equipment and to send the revised multi-radio access technology priority list to the user equipment via said wireless transceiver.

19. The wireless network node of claim 15, said at least one functional unit being responsive to the user equipment reselecting from a first radio access technology to a second radio access technology, each having an associated entry in the multi-radio access technology priority list, to determine a revised multi-radio access technology priority list to the user equipment and to send the revised multi-radio access technology priority list to the user equipment via said wireless transceiver.

20. The wireless network node of claim 15, where there are at least m potential radio access technology systems available to the wireless communication network, and where n≦m.

21. The wireless network node of claim 15, embodied at least in part in a Node-B.

22. The wireless network node of claim 15, embodied at least in part in a packet scheduler function.

23. The wireless network node of claim 15, wherein the wireless network node is configured to operate in a packet switched mode.

24. The wireless network node of claim 15, wherein the wireless network node is configured to operate in a circuit switched mode.

25. The wireless network node of claim 15, embodied at least in part in a measurement report handling and control function.

26. The wireless network node of claim 15, embodied at least in part in an integrated circuit.

27. A method, comprising:
storing information descriptive of a multi-radio access technology priority list comprising n entries (n>1) prioritized from a highest priority radio access technology to a lowest priority radio access technology, where an entry for the highest priority radio technology comprises a timer value;
sending measurement results to a wireless communications network for one of the n entries that is associated with a currently camped-on radio access technology and for one of the n entries that is associated with an active neighbor radio access technology; and
in response to detecting a loss of the highest priority radio access technology, initializing a timer to the timer value and terminating making further measurements from a cell associated with the highest priority radio access technology until the timer expires.

28. The method of claim 27, where the measurement results do not comprise measurement results for one of the n entries that is not associated with either the currently camped-on radio access technology and the active neighbor radio access technology.

29. The method of claim 27, where n≧3.

30. The method of claim 27, further comprising, in response to handing over from a first radio access technology to a second radio access technology, each having an associated entry in the multi-radio access technology priority list, storing a revised multi-radio access technology priority list.

31. The method of claim 27, further comprising, in response to reselecting from a first radio access technology to a second radio access technology, each having an associated entry in the multi-radio access technology priority list, storing a revised multi-radio access technology priority list.

32. The method of claim 27, where there are at least m potential radio access technology systems available to the wireless communication network, and where n≦m.

33. A computer program product embodied on a tangible medium and comprising instructions that, when executed by a data processor of a user equipment, result in operations that comprise:
storing information that includes information descriptive of a multi-radio access technology priority list comprising n entries (n>1) prioritized from a highest priority radio access technology to a lowest priority radio access technology, where an entry for the highest priority radio technology comprises a timer value;
sending measurement results to a wireless communications network for one of the n entries that is associated with a currently camped-on radio access technology and for one of the n entries that is associated with an active neighbor radio access technology; and
in response to detecting a loss of the highest priority radio access technology, initializing a timer to the timer value and terminating further measurements from a cell associated with the highest priority radio access technology until the timer expires.

34. The computer program product of claim 33, where the measurement results do not comprise measurement results for one of the n entries that is not associated with either the currently camped-on radio access technology and the active neighbor radio access technology.

35. The computer program product of claim 33, where n≧3.

36. The computer program product of claim 33, further comprising, in response to handing over from a first radio access technology to a second radio access technology, each having an associated entry in the multi-radio access technology priority list, an operation of storing a revised multi-radio access technology priority list.

37. The computer program product of claim 33, further comprising, in response to reselecting from a first radio access technology to a second radio access technology, each having an associated entry in the multi-radio access technology priority list, an operation of storing a revised multi-radio access technology priority list.

38. The computer program product of claim 33, where there are at least m potential radio access technology systems available to the wireless communication network, and where n≦m.

39. A user equipment, comprising at least one transceiver adapted for wireless communication with a plurality of different radio access technologies, further comprising a control unit operatively coupled with a memory that stores information descriptive of a multi-radio access technology priority list comprising n entries (n>1) prioritized from a highest priority radio access technology to a lowest priority radio access technology, where an entry for the highest priority radio technology comprises a timer value; said control unit adapted to send measurement results to a wireless communications network for one of the n entries that is associated with a currently camped-on radio access technology and for one of the n entries that is associated with an active neighbor radio access technology; and further adapted to respond to detecting a loss of the highest priority radio access technology to initialize a timer to the timer value and to terminate further measurements from a cell associated with the highest priority radio access technology until the timer expires.

40. The user equipment of claim 39, where the measurement results do not comprise measurement results for one of the n entries that is not associated with either the currently camped-on radio access technology and the active neighbor radio access technology.

41. The user equipment of claim 39, where n≧3.

42. The user equipment of claim 39, said control unit being further adapted to respond to handing over from a first radio access technology to a second radio access technology, each having an associated entry in the multi-radio access technology priority list, to receive a revised multi-radio access technology priority list.

43. The user equipment of claim 39, said control unit being further adapted to respond to reselecting from a first radio access technology to a second radio access technology, each having an associated entry in the multi-radio access technology priority list, to receive a revised multi-radio access technology priority list.

44. The user equipment of claim 39, where there are at least m potential radio access technology systems available to the wireless communication network, and where n≦m.

45. A method, comprising:
storing information descriptive of a radio access technology priority list comprising n entries (n>1) prioritized from a highest priority radio access technology to a lowest priority radio access technology; and
in response to being camped on a cell not associated with the highest priority radio access technology, initiating measurements of a cell associated with the highest priority radio access technology after a predetermined period of time elapses.

46. The method of claim 45, where the predetermined period of time is specified as part of the stored information.

47. An apparatus, comprising:
means for receiving from a wireless network node a radio access technology priority list comprising n entries (n>1) prioritized from a highest priority radio access technology to a lowest priority radio access technology;
means for storing the received radio access technology priority list; and
means, responsive to the apparatus being in communication with a cell not associated with the highest priority radio access technology, for initiating measurements of a cell associated with the highest priority radio access technology after a predetermined period of time elapses.

48. The apparatus of claim 47, where the predetermined period of time is specified as part of the received radio access technology priority list.
